(19) United States
(12) Patent Application Publication
(10) Pub. No.: US 2019/0064044 A1
(43) Pub. Date: Feb. 28, 2019

(54) SYSTEM OF AUTOMATION TECHNOLOGY

(71) Applicant: Endress+Hauser SE+Co. KG, Maulburg (DE)

(72) Inventors: Christian Strittmatter, Rickenbach (DE); Simon Gerwig, Schopfheim (DE); Harald Schäuble, Lörrach (DE); Wolfgang Brutschin, Schopfheim (DE)

(21) Appl. No.: 16/109,869

(22) Filed: Aug. 23, 2018

(30) Foreign Application Priority Data
Aug. 23, 2017 (DE) 10 2017 119 274.3

(51) Int. Cl. G01N 9/00

(52) U.S. Cl. CPC G01N 9/002; H04W 4/80

(57) ABSTRACT

A system of automation technology for determining density of a medium located in a container is provided. The system includes a first sensor unit for determining a temperature of the medium and, using a first sensor element, register the temperature of the medium and determine corresponding temperature values. The first sensor unit is configured to transmit the temperature values wirelessly. The system also includes a density measuring apparatus with at least one oscillatable unit at least partially exposed to the medium and an electronics unit. The electronics unit excites the oscillatable unit to execute mechanical oscillations with an oscillation frequency dependent on at least the density and temperature of the medium. Further, the electronics unit is configured to receive the temperature values of the medium from the first sensor unit and, based at least on the received temperature values and the oscillation frequency, determine and output density values.

### CROSS-REFERENCE TO RELATED APPLICATION

The present application is related to and claims the priority benefit of German Patent Application No. 10 2017 119 274.3, filed on Aug. 23, 2017, the entire contents of which are incorporated herein by reference.

### TECHNICAL FIELD

The present application relates to a system of automation technology for determining density of a medium located in a container.

### BACKGROUND

Known are apparatuses with at least one oscillatory element, so-called vibration detectors, for detecting or monitoring the fill level of a medium in a container. The oscillatory element is usually at least one oscillatory rod, which is secured to a membrane. The membrane is excited via an electro-mechanical transducer, e.g. a piezo-electrical element, to execute oscillations. Due to the oscillations of the membrane, the oscillatory element secured to the membrane also executes oscillatory movements.

Vibration detectors embodied as fill level measuring devices utilize the effect that the oscillation frequency and the oscillation amplitude depend on the degree of coverage of the oscillatory element: While the oscillatory element can execute oscillations in air freely and undamped, it experiences damping and, as a result thereof, a frequency and amplitude change, as soon as it is partially or completely disposed into the medium. Based on a predetermined frequency change, a unique inference of the particular fill level in the container can be made. Fill level measuring devices are often used as overfill protectors or for the purpose of protecting against a pump running empty.

Moreover, the oscillation frequency of the oscillatory element is also influenced by the density of the medium. Therefore, in the case of constant degree of coverage, there is a functional relationship with the density of the medium, such that vibration detectors are suitable both for fill-level measurement as well as also for density measurement. In practice, and for the purpose of monitoring and detecting fill level and/or density of a medium in a container, the oscillations of the membrane are sensed and converted by means of at least one piezoelement into electrical signals.

The electrical signals may then be evaluated by an evaluation unit, or density calculator, with which the density measuring device is connected by wire. The density calculator is located separated from the density measuring device in a circuitry cabinet and is connected therewith via separate lines for supplying the density measuring device with power and for transmission of the measured values. The density measuring device and/or fill-level measuring device, as well as the separate density calculator, may form a system for determining the fill level and/or the density of a medium.

The above described systems for measuring fill level and/or density are applied in a large number of industries, such as, for example, in the chemical industry, the food industry, and in the water treatment industry. The monitored fill substances may include substances ranging from water to yogurt, and may also include paints and lacquers, and high viscosity fill substances, such as honey, and foaming fill substances, such as beer.

A disadvantage of current conventional systems is that the fill-level measuring device and/or the density measuring device and the density calculator must be cumbersomely connected together over significant distances with multiple connection lines. This disadvantage becomes even more noticeable, when, for highly accurate measurements, it is realized that the above mentioned variables, fill level and density, are influenced by other physical variables, especially pressure and temperature, which must, in turn, be registered via separate pressure and temperature measuring devices, and transmitted to the separately arranged density calculator for purposes of compensation.

### SUMMARY

The present application discloses a system of automation technology for determining a density of a medium located in a container. The system includes a first sensor unit serving for determining a temperature of the medium and, based on a first sensor element, register the temperature of the medium and determine corresponding temperature values. The first sensor unit is configured to transmit the temperature values wirelessly.

The system also includes a density measuring apparatus with at least one oscillatable unit at least partially exposed to the medium, and an electronics unit. The electronics unit excites the oscillatable unit to execute mechanical oscillations with an oscillation frequency dependent on at least the density and the temperature of the medium. The electronics unit is configured to receive the temperature values of the medium transmitted wirelessly from the first sensor unit and, based at least on the received temperature values and the oscillation frequency, determine and output density values.

According to the present application, it is provided that compensation of density values based on temperature and/or pressure may occur directly in the density measuring apparatus.

An embodiment of the system of the present application further provides a second sensor unit for determining a pressure of the medium and, based on a second sensor element, register the pressure of the medium and determine corresponding pressure values. The second sensor unit is configured to transmit the pressure values wirelessly, and the electronics unit of the density measuring apparatus is further configured to receive the pressure values of the medium wirelessly transmitted from the second sensor unit and, based on the received pressure values, the received temperature values, and the oscillation frequency, determine and output density values.

Another embodiment of the system of the present application provides that the first sensor unit and/or second sensor unit are/is configured to transmit the temperature values and/or the pressure values wirelessly according to a Bluetooth standard or a variant based on the Bluetooth standard, such as, for example, Bluetooth 4.0 or higher.

In turn, another embodiment of the system of the present application further provides that the density measuring apparatus is configured to output the determined density values via an electrical current signal, such as, for example, a 4 to 20 milliamp (mA) electrical current signal.

According to another embodiment, the first sensor unit and/or second sensor unit are/is configured to transmit the temperature values and/or pressure values in the form of broadcast packets, and the electronics unit of the density measuring apparatus is configured to receive the broadcast packets and determine the temperature values and/or the pressure values from the broadcast messages, such that the temperature values and/or the pressure values can be used for determining the density values.

For example, the first sensor unit and/or the second sensor unit, as well as the electronics unit of the density measuring apparatus, may be configured to enable a first point-to-point connection between the electronics unit and the first sensor unit for wireless transmission of the temperature values and/or a second point-to-point connection between the electronics unit and the second sensor unit for wireless transmission of the pressure values. Further, the electronics unit of the density measuring apparatus may be configured to establish the first point-to-point connection and/or the second point-to-point connection to the first sensor unit and/or the second sensor unit, to receive the temperature values and the pressure values. Additionally or alternatively, the electronics unit of the density measuring apparatus may be configured to establish the first point-to-point connection to the first sensor unit and the second point-to-point connection to the second sensor unit in parallel, for example.

Another embodiment of the system of the present application provides that the density measuring apparatus is configured both as a master operation to receive the temperature values of the medium transmitted wirelessly from the first sensor unit and/or the pressure values of the medium transmitted wirelessly from the second sensor unit, and may be wirelessly configurable from an external device as a slave operation. Further, the density measuring apparatus may be configured to switch between master operation for receiving the temperature values and/or the pressure values and slave operation.

According to another embodiment of the system of the present application, the oscillatable unit and the electronics unit of the density measuring apparatus are arranged in a shared housing.

According to yet another embodiment of the system of the present disclosure, the first sensor unit and/or the second sensor unit are/is connected with the density measuring apparatus via at least one cable for energy supply, for example, such that the first sensor unit and/or the second sensor unit are/is supplied with energy from the density measuring apparatus via the cable such so that the temperature values and/or the pressure values may be transmitted wirelessly.

Yet another embodiment of the system of the present application provides that the first sensor unit and/or the second sensor unit are/is supplied with energy via at least one power supply arranged separated from the density measuring apparatus, such that the temperature values and/or pressure values may be transmitted wirelessly.

### BRIEF DESCRIPTION OF THE DRAWINGS

The present application will now be explained in greater detail based on the appended drawing, the figures of which show as follows:

FIG. 1 shows a prior art system of automation technology for determining density of a medium located in a container;

FIG. 2 shows a prior art density measuring apparatus that may be used in the system for determining the density of the medium; and

FIG. 3 shows a system of automation technology according to the present application for determining density of a medium located in a container.

### DETAILED DESCRIPTION

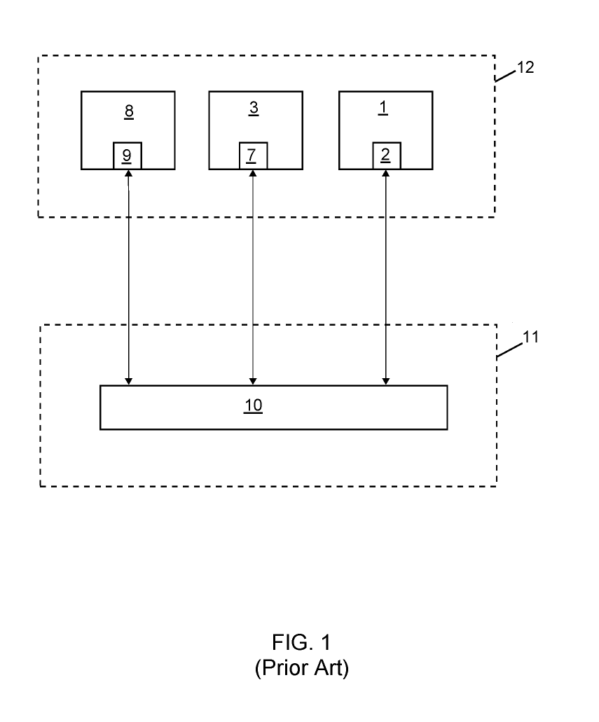

FIG. 1, labeled “Prior Art,” represents a conventional system of automation technology for determining density of a medium 17, such as, for example, a non-flowing medium, located in a container. The system includes, in such case, a first sensor unit 1 for temperature registration, a second sensor unit 3 for pressure registration, and a third sensor unit in the form of a density measuring apparatus 8, all three of which are secured on a container, which is filled with a medium 17. The three sensor units 1, 3 and 8 form a measuring environment 12 located on the container. Located separately, or independently, from the measuring environment 12 is an evaluation unit, in the form of a density calculator 10, which is also part of the system.

The first sensor unit 1 includes a sensor element 2 for registering a temperature of the medium in the container. For example, the sensor element 2 can include a PT100 element, which changes its resistance value as a function of the temperature of the medium. This change is detected by an evaluating electronics device located within the first sensor unit 1, converted into a temperature output signal dependent on the temperature of the medium, and provided at a sensor interface of the first sensor unit 1.

The second sensor unit 3 includes a sensor element 7 for pressure registration of a pressure in the container. For example, the sensor element 7 can have a piezoresistive or capacitive element, which changes its electrical properties as a function of the pressure. This change is detected by an evaluating electronics device located within the second sensor unit 3, converted into a pressure output signal dependent on the pressure, and provided at a sensor interface of the second sensor unit 3.

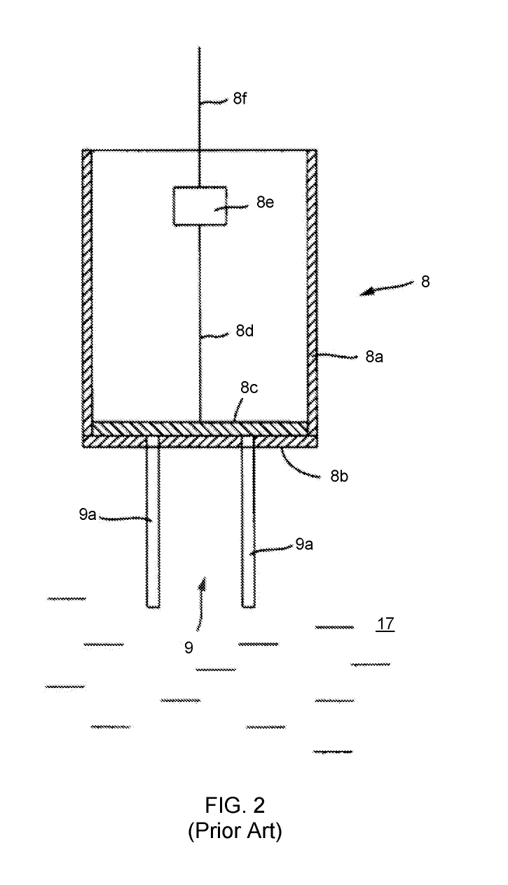

The third sensor unit in the form of the density measuring apparatus 8 shown in FIG. 2 (also labeled “Prior Art”), includes a sensor tube 8a, which is sealed by a membrane 8b at an end region facing the medium 17. Secured on an outer surface of the membrane 8b is an oscillatable unit 9 embodied as a tuning fork with two tines 9a. Only when the shape and the mass of the two tines 9a are at least approximately equal can the harmonic oscillation required for operating the density measuring apparatus 8 be implemented. The two tines 9a are embodied in the form of paddles, as is typical with vibronic sensors of measurement technology.

Further, the density measuring apparatus 8 includes an excitation unit 8c, which excites the membrane 8b with the oscillatory element to execute oscillations and receive the oscillations. A control/evaluation unit 8e, which is connected with the excitation unit 8c via an electrical connection 8d, determines, based on the received oscillations, the uncompensated, i.e., compensated neither for temperature nor for pressure, density of the medium. The control/evaluation unit 8e provides the determined density of the medium 17 in the form of a pulse frequency modulated pressure output signal via a sensor interface 8f of the density measuring apparatus.

As evident from FIG. 1, the evaluation unit, i.e., the density calculator, 10 is located in a circuitry cabinet 11, which is located separately, or independently, from the actual measuring environment 12. In order to evaluate the sensor data of the three sensor units 1, 3, 8, the evaluation unit 10 is connected, in each case, via a wired connection with each of the sensor units 1, 3 and 8. For example, the evaluation unit 10 can be connected with the first, the second, and the third sensor unit 1, 3, and 8 via, in each case, a two-wire line. Via each two-wire line, the three sensor units 1, 3, and 8 are supplied with energy by the evaluation unit 10 and transmit their data to the evaluation unit 10. For transmitting the sensor data, usually a 4 to 20 mA electrical current signal is used. In this way, the temperature output signal, the pressure output signal, and the density output signal are transmitted to the density calculator, which, based on the transmitted values of temperature and pressure, provides a compensated density signal.

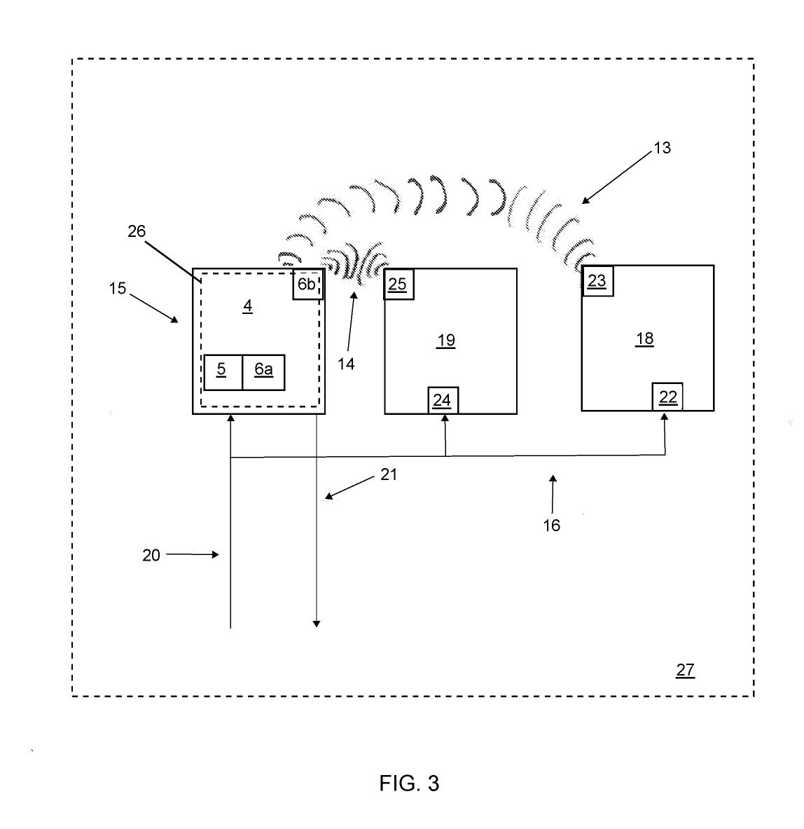

FIG. 3 represents a system of the present application for automation technology for determining density of a medium, such as, for example, a non-flowing medium, in a container. The system of the present application includes at least a first sensor unit 18 for determining a temperature of the medium and a density measuring apparatus 4. Further, the system can supplementally have a second sensor unit 19 for determining a pressure of the medium.

The first sensor unit 18 of the system of the present application registers, based on a sensor element 22, the temperature of the medium and determines corresponding temperature values. The first sensor unit 18 is, for example, via a corresponding internal electronics unit 23, i.e., one disposed within the first sensor unit 18, configured to wirelessly transmit the determined temperature values. For example, the first sensor unit 18 may be adapted in such a manner that the temperature values are transmitted wirelessly according to a Bluetooth standard or a variant based on the Bluetooth standard, such as, for example, Bluetooth 4.0 or higher. For this, the internal electronics unit 23 may include a correspondingly installed radio antenna and corresponding radio electronics. The internal electronics unit 23 may be embodied in such a manner that the temperature values are transmitted in the form of broadcast packets, or broadcast messages. In supplementation or alternatively, the internal electronics unit 23 of the first sensor unit 18 may be adapted to enable a first point-to-point connection 13 for wireless transmission of the temperature values.

The second sensor unit 19 of the system of the present application may register, based on a sensor element 24, the pressure of the medium and determine corresponding pressure values. The second sensor unit 19 may include an internal electronics unit 25, i.e., one disposed within the second sensor unit 19, that may be configured to wirelessly transmit the determined pressure values. For example, the second sensor unit 19 may be adapted in such a manner that the pressure values are transmitted wirelessly according to a Bluetooth standard or a variant based on the Bluetooth standard, for example, Bluetooth 4.0 or higher. For this, the internal electronics unit 25 may include a correspondingly installed radio antenna and corresponding radio electronics. The internal electronics unit 25 may be embodied in such a manner that the pressure values are transmitted in the form of broadcast packets, or broadcast messages. In supplementation or alternatively, the internal electronics unit 25 of the second sensor unit 19 may be configured to enable a second point-to-point connection 14 for wireless transmission of the pressure values.

The density measuring apparatus 4 of the system of the present application is modified compared with the density measuring apparatus 8 of FIG. 2 such that an internal electronics unit 26 not only includes a control/evaluation unit 6a corresponding to the density measuring apparatus of FIG. 2, but also includes a radio antenna and radio electronics 6b, which are configured to receive the temperature values of the medium transmitted wirelessly from the first sensor unit 18. The wirelessly received temperature values can then be used by the control/evaluation unit 6a to ascertain at least temperature compensated density values. These can, in turn, be output via an interface of the density measuring apparatus 4, and, for example, may be in the form of an electrical current signal, such as, for example, a 4 to 20 mA electrical current signal.

In supplementation thereof, the internal electronics unit 26 of the density measuring apparatus 4 may also be adapted to receive the pressure values of the medium transmitted wirelessly from the second sensor unit 19. The wirelessly received pressure values can then be used by the control/evaluation unit 6a to perform a pressure compensation of the density of the medium.

In supplementation, the internal electronics unit 26 of the density measuring apparatus 4 can be adapted to receive the broadcast packets, or messages, transmitted from the first and second sensor units 18, 19 and to extract from the received broadcast packets the temperature values and/or pressure values, so that the values can be used for compensating the density values.

Further, the internal electronics unit 26 of the density measuring apparatus 4 may be adapted for master operation, such that, in each case, a wireless point-to-point connection 13, 14, such as, for example, an alternating connection, can be established to the first and/or second sensor unit 18, 19. By master operation, the temperature values and/or the pressure values may be transmitted wirelessly via the particular point-to-point connection 13, 14. In such case, the internal electronics unit 26 can be embodied in such a manner that, in each case, wireless point-to-point connections 13, 14 can be established to the first and second sensor units 18, 19 in parallel, i.e., simultaneously. For example, the internal electronics unit 26 may have two radio antennas and two radio electronics devices. Alternatively, the internal electronics unit 26 may have only one radio antenna and one radio electronics device, which alternately, i.e., at times offset relative to one another, establishes point-to-point connections 13, 14 to the first and second sensor elements 18, 19.

The internal electronics unit 26, additionally or alternatively to master operation also may be adapted for slave operation, in which the density measuring apparatus 4 is wirelessly configurable, for example, via a mobile servicing device. In slave operation, parameters may be transmitted from the mobile servicing device, for example, a smart phone, tablet, etc., wirelessly to the density measuring apparatus 4 and used by the internal electronics unit 26 after the transmission.

In addition, the internal electronics unit 26 may be configured to switch between master operation and slave operation to receive the temperature and pressure values for density determination and, also, to be ready for a possible parametering by the mobile service unit. The switching between master and slave operation may occur, for example, alternately, or periodically.

For energy supply, the first and/or the second sensor units 18, 19 may be connected via a cable 16, such as, for example, a two conductor cable, with the density measuring apparatus 4 located within a measuring environment 27. In contrast to the system of FIG. 1, only energy supply takes place via the cable 16. The transmission of the measured values occurs, such as above described, wirelessly. This offers the advantage that the first and/or second sensor unit 18, 19 do/does not have to be connected cumbersomely by cable to a density calculator arranged separately, or independently, from the container and, thus, from the measuring environment 27. Instead, the first and/or second sensor unit are/is connected only to the density measuring apparatus 4, which is also located on the container in the measuring environment 27.

Additionally or alternatively, the first and/or the second sensor unit 18, 19 may be supplied with energy via at least one power supply arranged separately, or independently, from the density measuring apparatus 4, but located on the container and, thus, in the measuring environment 27, with the temperature values and/or pressure values being transmitted wirelessly.

The density measuring apparatus 4 may be supplied via a separate energy line 20. Alternatively, however, the density measuring apparatus 4 may also receive energy via the 4 to 20 mA line, such as, for example, the two-wire line 21, via which the ascertained density values are transmitted in the form of a 4 to 20 mA electrical current signal.

1. A system of automation technology for determining a density of a medium located in a container, comprising:
a first sensor unit for determining a temperature of the medium and, using a first sensor element, to register the temperature of the medium and determine corresponding temperature values, wherein the first sensor unit is configured to transmit the temperature values wirelessly; and
a density measuring apparatus with an electronics unit and at least one oscillatable unit at least partially exposed to the medium;
wherein the electronics unit excites the oscillatable unit to execute mechanical oscillations with an oscillation frequency dependent on at least the density and the temperature of the medium, and is configured to receive the temperature values of the medium transmitted wirelessly from the first sensor unit and, based at least on the received temperature values and the oscillation frequency, to determine and output density values.

2. The system of claim 1, further including a second sensor unit for determining a pressure of the medium and, using a second sensor element, register the pressure of the medium and determine corresponding pressure values, wherein the second sensor unit is configured to transmit the pressure values wirelessly; and wherein the electronics unit of the density measuring apparatus is configured to receive the pressure values of the medium transmitted wirelessly from the second sensor unit and, based on the received pressure values, received temperature values, and the oscillation frequency, determine and output density values.

3. The system of claim 2, wherein the first sensor unit and/or the second sensor unit are/is further configured to transmit at least one of the temperature values and/or the pressure values wirelessly according to a Bluetooth standard or a variant based on the Bluetooth standard.

4. The system of claim 1, wherein the density measuring apparatus is configured to output the ascertained density values via an electrical current signal.

5. The system of claim 4, wherein the electrical current signal is a 4 to 20 milliamp electrical current signal.

6. The system of claim 2, wherein the first sensor unit and/or the second sensor unit are/is further configured to transmit the temperature values and/or the pressure values in the form of broadcast packets and the electronics unit of the density measuring apparatus is further configured to receive the broadcast packets and to determine the temperature values and/or the pressure values from the broadcast packets so that the temperature values and/or the pressure values are used for determining the density values.

7. The system of claim 2, wherein the first sensor unit and/or the second sensor unit and the electronics unit of the density measuring apparatus are configured to enable a first point-to-point connection between the electronics unit and the first sensor unit for wireless transmission of the temperature values and/or a second point-to-point connection between the electronics unit and the second sensor unit for wireless transmission of the pressure values.

8. The system of claim 7, wherein the electronics unit of the density measuring apparatus is further configured to establish the first point-to-point connection to the first sensor unit or the second point-to-point connection to the second sensor unit to receive the temperature values and the pressure values.

9. The system of claim 8, wherein the electronics unit of the density measuring apparatus is further configured to establish the first point-to-point connection to the first sensor unit and the second point-to-point connection to the second sensor unit in parallel to receive the temperature values and the pressure values.

10. The system of claim 2, wherein the density measuring apparatus is further configured in a master operation to receive the temperature values of the medium transmitted wirelessly from the first sensor unit and/or the pressure values of the medium transmitted wirelessly from the second sensor unit.

11. The system of claim 10, wherein the density measuring apparatus is wirelessly configurable from an external device in a slave operation.

12. The system of claim 11, wherein the density measuring apparatus is further configured to switch between the master operation for receiving the temperature values and/or the pressure values and the slave operation.

13. The system of claim 1, wherein the oscillatable unit of the density measuring apparatus and the electronics unit of the density measuring apparatus are arranged in a shared housing.

14. The system of claim 2, wherein the first sensor unit and/or the second sensor unit are/is connected with the density measuring apparatus via at least one cable for energy supply to enable transmission of the temperature values and/or pressure values wirelessly.

15. The system of claim 2, wherein the first sensor unit and/or the second sensor unit are/is supplied with energy via at least one power supply that is independent from the density measuring apparatus to enable transmission of the temperature values and/or pressure values wirelessly.
